(19) United States
(12) Patent Application Publication
(10) Pub. No.: US 2011/0108543 A1
(43) Pub. Date: May 12, 2011

(54) SELF CLEANING COOKING OVEN

(75) Inventors: Tobias Weber, Burk (DE); Dietmar Hildner, Furth (DE); Harald Poerner, Schnaittach (DE); Tobias Boeheim, Salach (DE); Bernd Heisswolf, Rothenburg ob der Tauber (DE)

(73) Assignee: ELECTROLUX HOME PRODUCTS CORPORATION N.V., Zaventem (BE)

(21) Appl. No.: 12/742,453

(22) PCT Filed: Nov. 13, 2008
(86) PCT No.: PCT/EP2008/009580

§ 371 Date: Jan. 19, 2011

(30) Foreign Application Priority Data
Nov. 26, 2007 (EP) 07022848.1

(51) Int. Cl. A21B 1/22; F27D 19/00

(52) U.S. Cl. 219/414; 219/391

(57) ABSTRACT

A self cleaning cooking oven comprises a cabinet having walls defining an oven cavity; a door for closing said oven cavity, a supporting structure for supporting a removable rack structure within said oven cavity, a heating means for heating said oven cavity, and a control means for said heating means selectively operable to control said heating means to effect a cooking operation or a pyrolysis operation, wherein the oven further comprises an actuation means which is removably positionable within said oven cavity by a user, said actuation means, when present within said oven cavity, directly or indirectly acts on said control means to control said heating means for effecting the pyrolysis operation.

### TECHNICAL FIELD

The present invention relates to a self cleaning cooking oven comprising a cabinet having walls defining an oven cavity, a door for closing said oven cavity, a supporting structure for supporting a removable rack structure within said oven cavity, a heating means for heating said oven cavity, and a control means for said heating means selectively operable to control said heating means to effect a cooking operation or a pyrolysis operation. Moreover, the present invention relates to a method for starting a pyrolysis operation of such an oven.

### BACKGROUND TECHNOLOGY

Typically, cooking ovens comprise an oven cavity, a door for closing the cavity, and a rack structure having one or more racks, brackets, or other components for supporting food items to be cooked, whereby said rack structure is arranged at a supporting structure within the oven cavity. During prolonged use of such ovens, smoke residue from cooking food items is deposited on the cavity's inner walls, which is difficult an inconvenient to remove manually.

In order to eliminate this inconvenient aspect, ovens have been developed which comprise a heating means adapted to effect a cooking operation as well as a pyrolysis operation that applies a maximum heat to an oven cavity to burn and remove such smoke residue. The operation mode of the heating means is controlled by a control means connected to a control panel which can be manipulated by the user. During the pyrolysis operation, however, the racks, brackets and other components present within the oven cavity may be damaged because of the extremely high temperatures associated with such pyrolysis operation. Accordingly, racks, brackets and other components present within the cavity must be removed prior to the activation of the pyrolysis operation.

However, it is easy for a user to forget to remove the components prior to the activation of the pyrolysis function. Moreover, the user may unintentionally activate the pyrolysis operation while the components are still arranged within the cavity. Therefore, racks, brackets and other components are often damaged and need to be replaced.

One approach for solving this problem is disclosed in DE 199 54 470 B4 which describes a cooking oven of the above-mentioned type comprising a cabinet having walls defining an oven cavity, a door for closing said oven cavity, a supporting structure for supporting a removable rack structure within said oven cavity, a heating means for heating said oven cavity, and a control means for said heating means selectively operable to control said heating means to effect a cooking operation or a pyrolysis operation. In order to remind the user of taking the rack structure out of the oven cavity prior to the activation of the pyrolysis operation, the oven further comprises a signal generation means generating an optical or acoustical signal as soon as the pyrolysis function is turned on. However, the user can still disobey the signal so that components remain within the cavity during the pyrolysis operation and become damaged. Moreover, such oven structure does not prevent an unintentional activation of the pyrolysis operation.

In order to reduce this damage potential, DE 199 54 470 B4 and U.S. Pat. No. 7,183,521 B2 both propose an oven comprising a detection device providing indication of an absence or presence of a rack structure within an oven cavity as well as an oven control, said oven control permitting the cleaning of the oven by means of a pyrolysis operation in response to the indication of the absence of said rack structure or preventing such operation in response to the indication of the presence of the rack structure. Although this oven structure is very effective with respect to a prevention of an activation of the pyrolysis operation while damageable components are present within the cavity, such structure is quite complex and expensive due to the detection device. Moreover, an unintentional activation of the pyrolysis operation is still possible when all components are taken out of the cavity.

Starting from the above mentioned prior art technology, it is an object of the present invention to provide an oven having an alternative structure eliminating one or more of the above mentioned drawbacks.

### DISCLOSURE OF THE INVENTION

This object is solved by providing an oven according to claim 1. The dependent claims refer to individual embodiments of the present invention.

The self cleaning cooking oven according to the present invention comprises a cabinet having walls defining an oven cavity; a door for closing said oven cavity; a supporting structure for supporting a removable rack structure within said oven cavity; a heating means for heating said oven cavity; and a control means for said heating means selectively operable to control said heating means to effect a cooking operation or a pyrolysis operation. The invention is characterized in that the oven further comprises an actuation means which is removably positionable within said oven cavity by a user, said actuation means, when present within said oven cavity, directly or indirectly acts on said control means to control said heating means for effecting the pyrolysis operation. Accordingly, the pyrolysis operation can be activated only by positioning the actuation means within the oven cavity. Thus, an unintended actuation of the pyrolysis function is prevented.

Preferably the actuation means is configured in such a manner that it is positionable within said oven cavity'only if no rack structure is present within said oven cavity. Accordingly, the pyrolysis operation can be activated only if no damageable component is present within the oven cavity. Thanks to this simple constructive solution no expensive detection means is necessary for detecting the absence or presence of a rack structure or other component within the cavity. Thus, a low cost oven can be achieved.

According to one possible aspect of the present invention, the actuation means is positionable at an inner face of said door in such a manner that the actuation means automatically acts on said control means when closing said door, i.e. the pyrolysis operation is activated automatically when closing the door. Accordingly, no control panel or separate switch is essential for starting the pyrolysis rendering the oven structure even simpler. However, it should be noticed that a pyrolysis switch can be provided.

According to a further possible aspect of the present invention, the supporting structure is arranged at the inner face of said door, and the actuation means is positionable at said supporting structure. Thus, no additional supporting structure is needed in order to fix the actuation means at the inner face of the door.

The control means may be arranged within the oven cavity so that the actuation means, when present within said oven cavity, directly acts thereon to control said heating means for effecting the pyrolysis operation. However, due to the high temperatures within the oven cavity and an impairment of serviceability of the control means possibly associated therewith, the control means is preferably positioned outside said oven cavity. In this case, a transmission device is advantageously provided between said actuation means and said control means in such a manner, that the actuation means acts on said transmission device and said transmission device acts on said control means in order to start the pyrolysis operation.

Moreover, the present invention provides a method for starting a pyrolysis operation of an inventive oven, comprising the steps of opening the door; removing of the rack structure, if present; fixing the actuation means and closing the door. In this case, the pyrolysis operation is started automatically by closing the door.

According to another aspect of the inventive method, the method further comprises the step of turning a pyrolysis switch on. In this case, the pyrolysis operation is activated by closing the door and by switching the pyrolysis switch on.

### BRIEF DESCRIPTION OF THE ACCOMPANYING DRAWINGS

The detailed configuration, features and advantages of the present invention will become apparent in the course of the following description with reference to the accompanying drawings.

FIG. 1 is a perspective view showing a part of an oven in accordance with one embodiment of the present invention;

FIG. 2 is another perspective view of the oven shown in FIG. 1;

FIG. 3 is a perspective view of a transmission device of the oven shown in FIGS. 1 and 2; and

FIG. 4 is an enlarged view of a control means shown in FIGS. 1 and 2.

### BEST MODE FOR CARRYING OUT THE INVENTION

Below, an embodiment of the present will be described with reference to the figures. In the figures, like parts or portions are denoted by like reference numerals and redundant descriptions will be omitted.

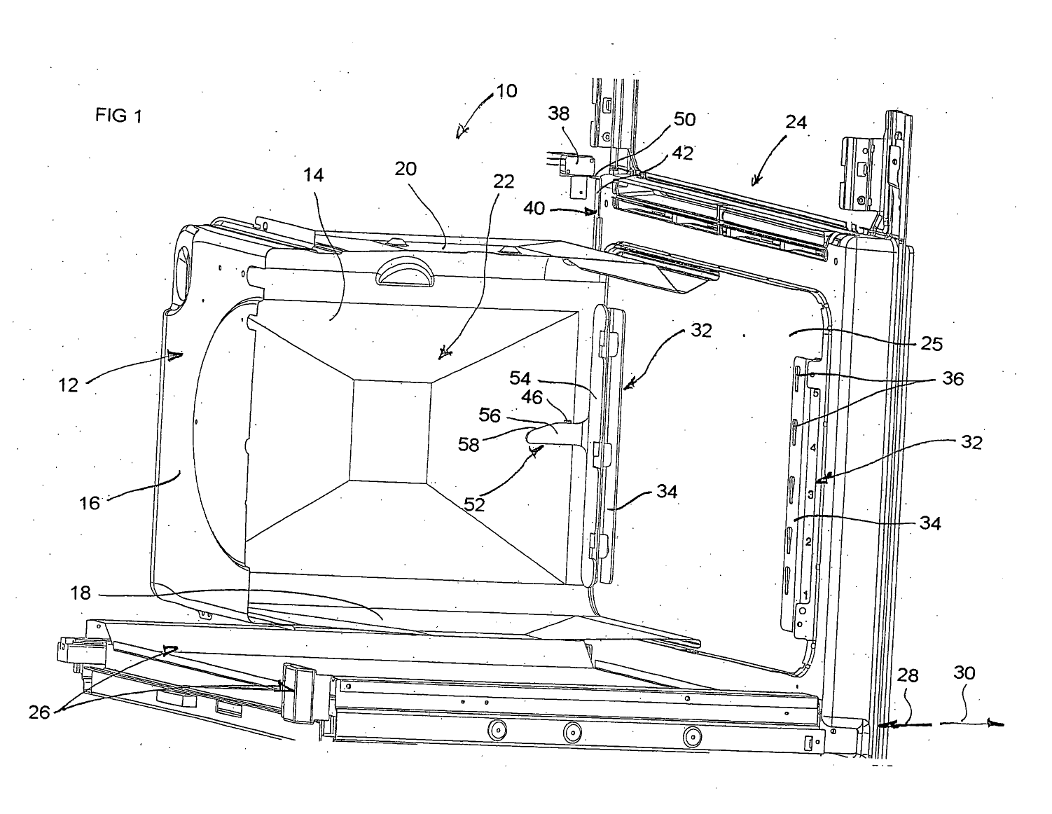

FIG. 1 is a perspective view showing a part of an oven 10 in accordance with one embodiment of the present invention. The oven 10 is one of the self cleaning type and is selectively operable in a cooking mode and in a pyrolysis mode. It comprises a cabinet 12 having two side walls 14 (only one is shown in the figures), a back wall 16, a bottom wall 18 and a top wall 20. The walls 14, 16, 18 and 20 define an oven cavity 22 in which foods to be cooked can be arranged. In order to show the inside of the oven cavity 22, only half of the cabinet 12 is illustrated in FIG. 1. For opening and closing the front of the cabinet 12, a door 24 is provided having a window 25 for monitoring the oven cavity 22 from the outside. The door 24 is supported and horizontally guided by guiding rails 26, so the door 24 is movable back and forth in direction of arrows 28 and 30. A supporting structure 32 for supporting a removable rack structure (not shown) is arranged at the inside face of the door 24. In the present embodiment, the supporting structure 32 is composed of two vertically extending rails 34 arranged at both sides of the window 25. Each rail 34 is formed with a number of slot like through holes 36 in which clamp like components of the rack structure can be inserted and hooked (not shown).

Moreover, the oven 10 comprises a heating means (not illustrated) for heating the oven cavity 22 and a control means 38 selectively operable to control said heating means to effect a cooking operation or a pyrolysis operation. Due to the high temperatures within the oven cavity 22, the control means is arranged outside the oven cavity 22 above the cabinet 12. In the present embodiment, it is provided in form of a simple on/off-switch.

Normally, the oven 10 is operated in the cooking mode. However, when the control means 38 is actuated by an actuation means described in more detail below, the heating means is controlled to effect a pyrolysis operation.

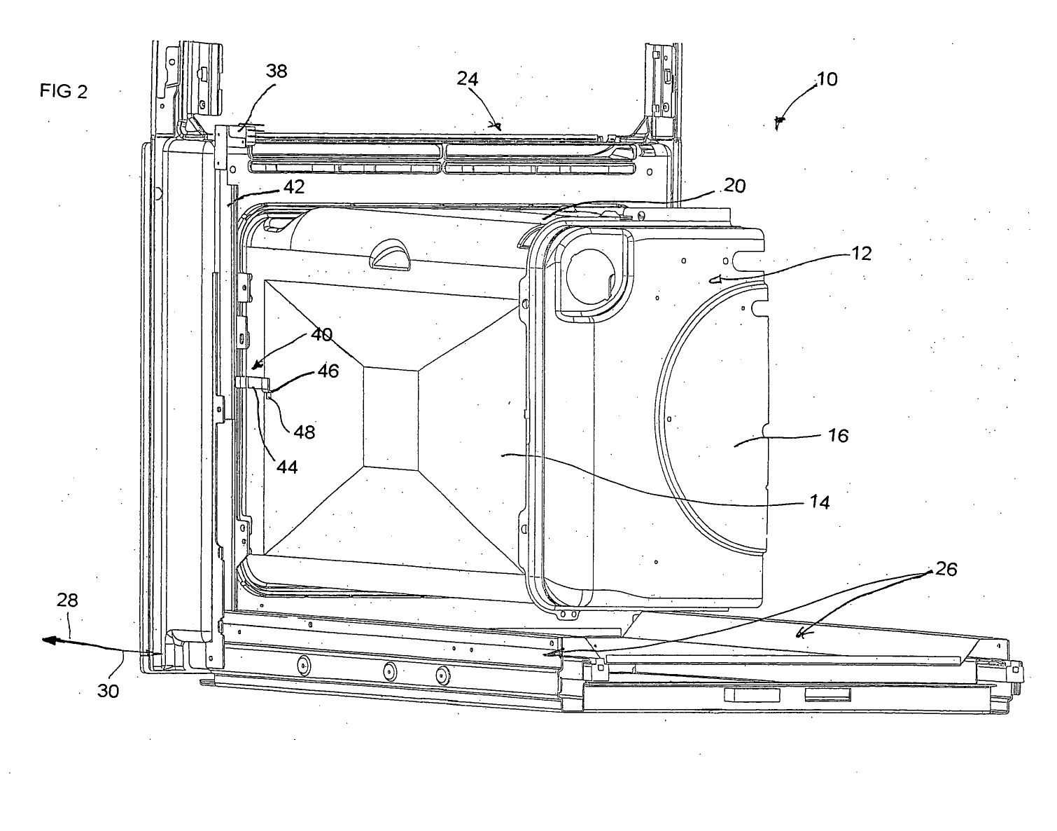

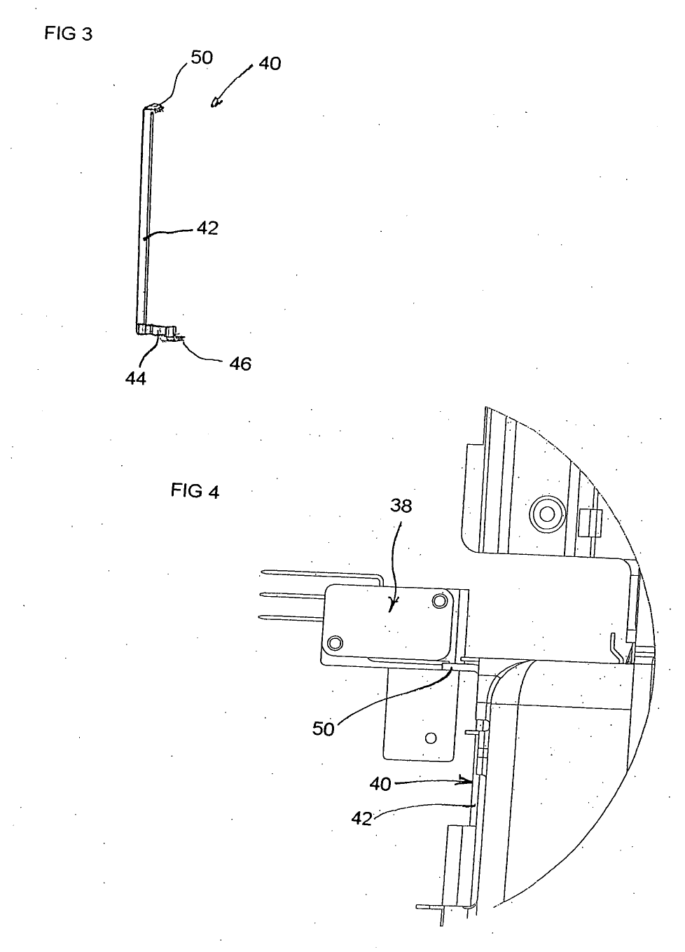

As illustrated best in FIG. 2, which is another perspective view of the oven shown in FIG. 1, a transmission device 40 extends vertically from the inside of the oven cavity 22 to the control means 38 along the outer side of side wall 14 and is supported and guided by means not shown in detail, so it can perform an upward movement to actuate the control means 38 for switching to the pyrolysis mode as well as a downward movement until it does not actuate the control means 38 any longer in order to perform a cooking operation. As it is best shown in FIG. 3, which is a perspective view of the transmission device 40, the transmission device 40 is formed as a one piece component and comprises a bar like main portion 42 extending vertically along the outer side of side wall 14, a transition portion 44 extending horizontally from the lower end of the main portion 42, a nose portion 46, which extends horizontally from and perpendicular to the transition portion 44 and projects through a through hole 48 formed in the side wall 14 into the oven cavity 22, and an actuation portion 50 acting on the control means 38, the actuation portion 50 extending from the upper end of the main portion 42 and in parallel to the nose portion 44.

Normally, the transmission device 40 is positioned in it lower position. This can be realized by gravity, i.e. by its self-weight, or by means of an element, e.g. a compression spring, which pushes the transmission device downward. In order to realize an upward movement of the transmission device 40 to actuate the control means 38 for performing the pyrolysis operation, an actuation means 52 can be fixed at the supporting structure 32 at the inside face of the door 24. In the present embodiment, the actuation means 52 comprises a long plate like portion 54 provided with clamps on its backside, which can be inserted through the through holes 36 of one rail 34 of the supporting structure 32 and hooked therein. The length of the plate like portion 54 is chosen such that the plate like portion 54 covers all the through holes 32 of the rail 34. Thus, it can be ensured, that no rack structure is supported by the supporting structure 32. Accordingly, no rack structure can be damaged when performing the pyrolysis function of the oven 10. Moreover, the actuation means 52 comprises a projecting portion 56, which extends from the plate like portion 54 such that it is arranged in parallel an close to the side wall 14 within the oven cavity 22, when the door 24 is in its closed position. The projecting portion 56 is provided with an inclined section 58, which contacts and pushes the nose portion 44 and hence the transmission device 40 upward bit by bit, when the door 24 of the oven is closed, until, as best shown in FIG. 4, the actuation portion 50 of the transmission device 40 actuates the control means 38 to switch over to the pyrolysis mode. Accordingly, the pyrolysis operation of the oven 10 is chosen automatically by providing the actuation means 52 at the supporting structure 32 and by closing the door 24. Alternatively, a pyrolysis switch may be provided at a control panel (not shown), which additionally needs to be activated in order to start the pyrolysis mode.

As soon as the pyrolysis operation is completed, the door 24 can be opened. When opening the door 24, the inclined section 58 of the projecting portion 56 of the actuation means 52 comes out of contact with the nose portion 44 of the transmission device 40. Thus, the transmission device 40 performs a downward movement and returns to its lower position, so that the actuation portion 50 does not actuate the control means 38 any longer. Accordingly, the oven automatically switches back to its cooking mode. Afterwards, the actuation means 52 can be removed from the door 24 and a rack structure may be fixed at the supporting structure 32.

The present invention is not limited to the above-described embodiment, but various changes may be made without departing from the scope of the invention defined in the accompanying claims.

For example, the extractable door of the embodiment may be replaced by a pivoting door.

Moreover, the supporting structure does not have to be mounted at the door. It can also be provided at the sidewalls of the cabinet. In addition, the actuation means need not to be arranged at the supporting structure but can be fixed by means of other fixing means.

Furthermore, the actuation means as well as the transmission device may be formed and arranged differently, as long as the actuation means can actuate the control means. In addition, the transmission device is not essential. The actuation means may actuate the control means directly.

Although only one exemplary embodiment of this invention has been described in detail above, those skilled in the art will readily appreciate that many modifications are possible with respect to the exemplary embodiment without materially departing from the novel teachings and advantages of this invention. Accordingly all such modifications are intended to be included within the scope of this invention.

### REFERENCE NUMERALS

10 oven
12 cabinet
14 side walls
16 back wall
18 bottom wall
20 top wall
22 oven cavity
24 door
25 window
26 guiding rails
28 arrow
30 arrow
32 supporting structure
34 rail
36 through hole
38 control means
40 transmission device
42 main portion
44 transition portion
46 nose portion
48 through hole
50 actuation portion
52 actuation means
54 plate like portion
56 projecting portion
58 inclined section

1. A self cleaning cooking oven (10) comprising a cabinet (12) having walls defining an oven cavity (22); a door (24) for closing said oven cavity (22), a supporting structure (32) for supporting a removable rack structure within said oven cavity (22), a heating means for heating said oven cavity (22), and a control means (38) for said heating means selectively operable to control said heating means to effect a cooking operation or a pyrolysis operation, characterized in that the oven further comprises an actuation means (52)—which is removably positionable within said oven cavity (22) by a user, said actuation means (52), when present within said oven cavity (22), directly or indirectly acts on said control means (38) in order to control said heating means to effect the pyrolysis operation.

2. An oven (10) according to claim 1, characterized in that the actuation means (52) is configured in such a manner that it is positionable within said oven cavity (22) only if no rack structure is present within said oven cavity (22).

3. An oven (10) according to claim 1, characterized in that said actuation means (52) is positionable at an inner face of said door (24) in such a manner that the actuation means (52) is positioned within the oven cavity (22) and acting directly or indirectly on said control means (38) by closing said door (24).

4. An oven (10) according to claim 3, characterized in that the supporting structure (32) is arranged at the inner face of said door (24), and in that the actuation means (52) is positionable at said supporting structure (32).

5. An oven (10) according to claim 1, characterized in that said control means (38) is positioned outside said oven cavity (22).

6. An oven (10) according to claim 5, characterized in that a transmission device (44) is provided between said actuation means (52) and said control means (38) in such a manner, that the actuation means (52) acts on said transmission device (44) and said transmission device (44) acts on said control means (38).

7. A method for starting a pyrolysis operation of an oven (10) according to claim 1, comprising the steps of opening the door (24); Removing of the rack structure; Fixing the actuation means (52) and—Closing the door (24).

8. A method according to claim 7, further comprising the step of turning a pyrolysis switch on.
